(19) United States
(12) Patent Application Publication
(10) Pub. No.: US 2019/0166513 A1
(43) Pub. Date: May 30, 2019

(54) CSI-RS Radio Resource Management (RRM) Measurement

(71) Applicant: MEDIATEK INC., Hsinchu (TW)

(72) Inventor: Hsuan-Li Lin, Hsinchu (TW)

(21) Appl. No.: 16/200,646

(22) Filed: Nov. 27, 2018

Related U.S. Application Data
(60) Provisional application No. 62/591,286, filed on Nov. 28, 2017.
(60) Provisional application No. 62/616,631, filed on Jan. 12, 2018.

(51) Int. Cl. H04W 24/08; H04W 72/04; H04L 5/00

(52) U.S. Cl. CPC H04W 24/08; H04W 88/02; H04L 5/0048; H04W 72/0446

(57) ABSTRACT

A method of channel state information reference signal (CSI-RS) radio resource management (RRM) measurement is proposed. A UE receives RRM measurement configuration from a BS via RRC signaling. The RRM measurement configuration comprises CSI-RS resource information, cell IDs, and associated SSB indication. The UE decides frequency resources of CSI-RS according to the configured RRC parameters. UE performs cell search within synchronization signal block (SSB) measurement timing configuration (SMTC) window to know the detected SSBs and the corresponding detected cell IDs and symbol timing of detected cells. UE then decides timing resources of the CSI-RS according to the timing reference. If the detected cell ID matches the cell ID configured for the CSI-RS resource, UE performs measurements on the CSI-RS resources based on the symbol timing of the detected SSB.

### CROSS REFERENCE TO RELATED APPLICATIONS

This application claims priority under 35 U.S.C. § 119 U.S. provisional application 62/591,286 entitled “Spatial QCL for CSI-RS RRM” filed on Nov. 28, 2017, and application 62/616,631 entitled “Frequency and Time Resource Determination of CSI-RS RRM” filed on Jan. 12, 2018, the subject matter of which is incorporated herein by reference.

### TECHNICAL FIELD

The disclosed embodiments relate generally to wireless communication, and, more particularly, to method and apparatus for radio resource management (RRM) measurement of Channel State Information reference signal (CSI-RS).

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The Next Generation Mobile Network (NGMN) board, has decided to focus the future NGMN activities on defining the end-to-end requirements for 5G new radio (NR) systems.

For radio resource management (RRM) measurement in NR, UE can be configured to measure synchronization signal (SS) blocks (SSB) and/or channel state information (CSI) reference signal (CSI-RS). For CSI-RS RRM measurement, both frequency and timing resources need to be determined. In frequency domain, cell-specific bandwidth (BW) for CSI-RS is proposed in NR as compared to carrier-specific BW in LTE. In addition, the relationship between CSI-RS resources and bandwidth path (BWP) is unclear since the CSI-RS resources and BWP are configured separately. In time domain, the timing reference of the CSI-RS resources is referenced to a frame boundary of the target carrier, which may not be known to UE.

Typically, UE detects SSB to acquire timing synchronization of a cell, then applies the acquired timing to measure the CSI-RS associated to the cell. If the SSB of cell A has good channel quality, then it could imply the CSI-RS of cell A could have good channel quality. Therefore, UE can down-select some CSI-RSs to perform measurement, according to the channel quality of associated cells, rather than performing measurement on all configured CSI-RSs. In addition, the TX beam direction could be used to down-select some CSI-RSs to be measured. The idea is UE can down-select some CSI-RSs to perform measurement, according to the channel quality of associated SSBs, and those SSBs that are spatially quasi-co-located (QCLed) to CSI-RS. However, the definition of spatial QCL is unclear and UE is not able to leverage the QCL information for CSI-RS RRM measurement.

A solution is sought.

### SUMMARY

A method of channel state information reference signal (CSI-RS) radio resource management (RRM) measurement is proposed. A UE receives RRM measurement configuration from a BS via RRC signaling. The RRM measurement configuration comprises CSI-RS resource information, cell IDs, and associated SSB indication. The UE decides frequency resources of CSI-RS according to the configured RRC parameters. UE performs cell search within synchronization signal block (SSB) measurement timing configuration (SMTC) window to know the detected SSBs and the corresponding detected cell IDs and symbol timing of detected cells. UE then decides timing resources of the CSI-RS according to the timing reference. If the detected cell ID matches the cell ID configured for the CSI-RS resource, UE performs measurements on the CSI-RS resources based on the symbol timing of the detected SSB.

In one embodiment, a UE receives a radio resource management (RRM) measurement configuration in a new radio (NR) network. The RRM measurement configuration comprises resource information for a plurality of channel state information reference signals (CSI-RSs). The UE detects synchronization signal blocks (SSBs) and corresponding detected cell IDs and symbol timings of detected cells. The UE determines timing references of the plurality of CSI-RSs according to the detected symbol timings. The UE performs RRM measurement of a selected CSI-RS using a symbol timing of a detected cell when a detected cell ID of the detected cell matches a configure cell ID for the selected CSI-RS.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a new radio (NR) wireless system with SS block and/or CSI-RS measurement configured for the radio resource management (RRM) measurement in accordance with embodiments of the current invention.

FIG. 2 shows simplified block diagrams of a UE and a BS in accordance with embodiments of the current invention.

FIG. 3 illustrates frequency resources of CSI-RS for RRM measurement in accordance with one novel aspect of the present invention.

FIG. 4 illustrates addition details of frequency resources of CSI-RS for RRM measurement.

FIG. 5 illustrates time resources of CSI-RS for RRM measurement in accordance with one novel aspect of the present invention.

FIG. 6 illustrates one embodiment of utilizing QCL information in determining timing reference for CSI-RS RRM measurements.

FIG. 7 is a flow chart of a method for CSI-RS RRM measurements in accordance with embodiments of the current invention.

### DETAILED DESCRIPTION

Reference will now be made in detail to some embodiments of the invention, examples of which are illustrated in the accompanying drawings.

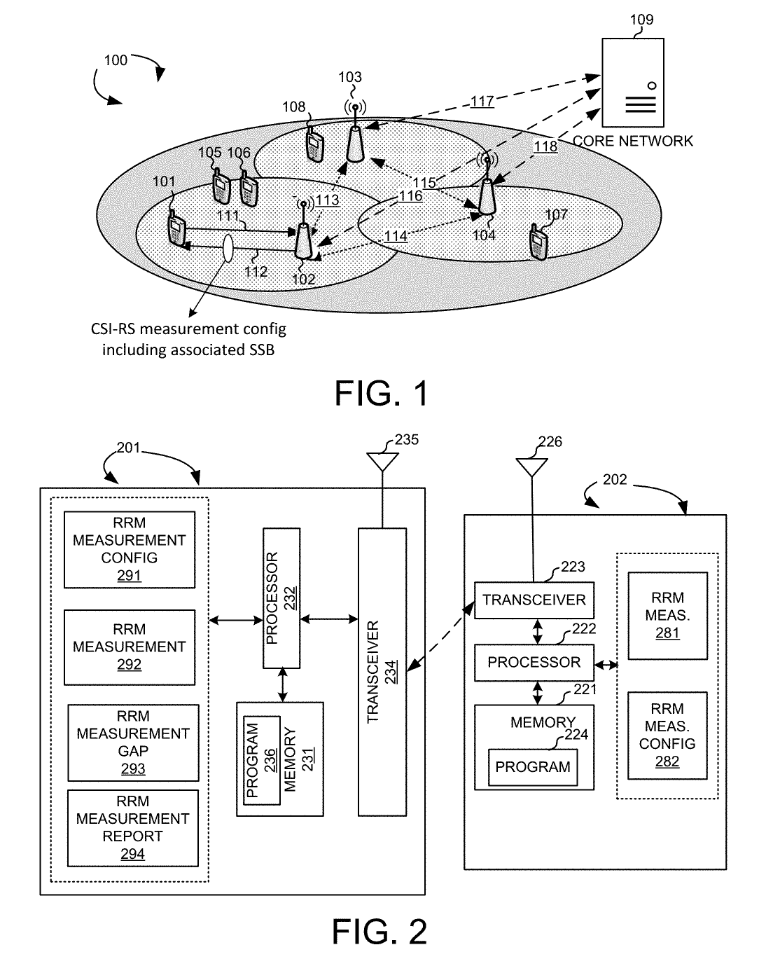

FIG. 1 illustrates a system diagram of a new radio (NR) wireless system 100 with synchronization signal block (SSB) and/or channel state information reference signal (CSI-RS) measurement configured for radio resource management (RRM) measurement in accordance with embodiments of the current invention. Wireless communication system 100 comprises one or more wireless networks having fixed base infrastructure units, such as receiving wireless communications devices or base units 102 103, and 104, forming wireless radio access networks (RANs) distributed over a geographical region. The base units may also be referred to as an access point (AP), an access terminal, a base station (BS), a Node-B, an eNodeB, an eNB, a gNodeB, a gNB, or by other terminology used in the art. Each of the base unit 102, 103, and 104 serves a geographic area and connects to a core network 109 e.g., via links 116, 117, and 118 respectively. The base unit performs beamforming in the NR system, e.g., utilizing Millimeter Wave frequency spectrum. Backhaul connections 113, 114 and 115 connect the non-co-located receiving base units, such as 102, 103, and 104. These backhaul connections can be either ideal or non-ideal.

A wireless communications device UE 101 in wireless system 100 is served by base station 102 via uplink 111 and downlink 112. Other UEs 105, 106, 107, and 108 are served by different base stations. UEs 105 and 106 are served by base station 102. UE 107 is served by base station 104. UE 108 is served by base station 103. Each UE may be a smart phone, a wearable device, an Internet of Things (IoT) device, a tablet, etc. For radio resource management (RRM) measurement in NR, each UE can be configured to measure synchronization signal (SS) blocks (SSB) and/or channel state information (CSI) reference signal (CSI-RS). For CSI-RS RRM measurement, both frequency and timing resources need to be determined.

In accordance with one novel aspect, UE 101 receives RRM measurement configuration from BS 102 via RRC signaling. The RRM measurement configuration comprises CSI-RS resource information, cell IDs, and optionally associated SSB indication. UE 101 decides frequency resources of CSI-RS according to the configured RRC parameters. UE 101 performs cell search within SSB measurement timing configuration (SMTC) window to know the detected SSBs and the corresponding detected cell IDs and symbol timing of detected cells. UE 101 then decides timing resources of the CSI-RS according to the timing reference. If the detected cell ID matches the cell ID configured for the CSI-RS resource, UE 101 performs measurements on the CSI-RS resources based on the symbol timing of the detected SSB. In one embodiment, if associated SSB indication is provided, UE 101 acquires the SSB index if the cell ID configured for the CSI-RS is detected by the SSB. UE 101 obtains the slot location of the configured CSI-RS by shifting the detected SSB by the configured slot offset. In one specific embodiment, Spatial Quasi-Co-Location-alike (SQclA) indication is provided to UE 101, which can be used by UE 101 to down-select CSI-RS for measurements.

FIG. 2 shows simplified block diagrams of a wireless devices, e.g., UE 201 and base station 202 in accordance with the current invention. Base station 202 has an antenna 226, which transmits and receives radio signals. A RF transceiver module 223, coupled with the antenna, receives RF signals from antenna 226, converts them to baseband signals and sends them to processor 222. RF transceiver 223 also converts received baseband signals from processor 222, converts them to RF signals, and sends out to antenna 226. Processor 222 processes the received baseband signals and invokes different functional modules to perform features in base station 202. Memory 221 stores program instructions and data 224 to control the operations of base station 202. Base station 202 also includes a set of control modules and circuits, such as an RRM measurement circuit 181 that performs RRM measurements and an RRM measurement configuration circuit 12 that configures RRM measurements for UEs and communicates with UEs to implement the RRM measurement functions.

Similarly, UE 201 has an antenna 235, which transmits and receives radio signals. A RF transceiver module 234, coupled with the antenna, receives RF signals from antenna 235, converts them to baseband signals and sends them to processor 232. RF transceiver 234 also converts received baseband signals from processor 232, converts them to RF signals, and sends out to antenna 235. Processor 232 processes the received baseband signals and invokes different functional modules to perform features in mobile station 201. Memory 231 stores program instructions and data 236 to control the operations of mobile station 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines.

UE 201 also includes a set of control modules and circuits that carry out functional tasks. These functions can be implemented in software, firmware and hardware. A processor in associated with software may be used to implement and configure the functional features of UE 201. For example, an RRM measurement configuration circuit 291 configures an RRM measurement configuration. The RRM measurement configuration includes frequency and time resource configuration for channel state information reference signal (CSI-RS) measurement, cell IDs, and associated SSB information with SQclAed indication. An RRM measurement circuit 292 performs an RRM measurement based on the RRM measurement configuration and the measurement gap configuration. An RRM measurement gap circuit 293 obtains a measurement gap configuration such that all configured RRM measurements are performed within one configured measurement gap. An RRM measurement report circuit 294 transmits a measurement report to the NR network for RRM.

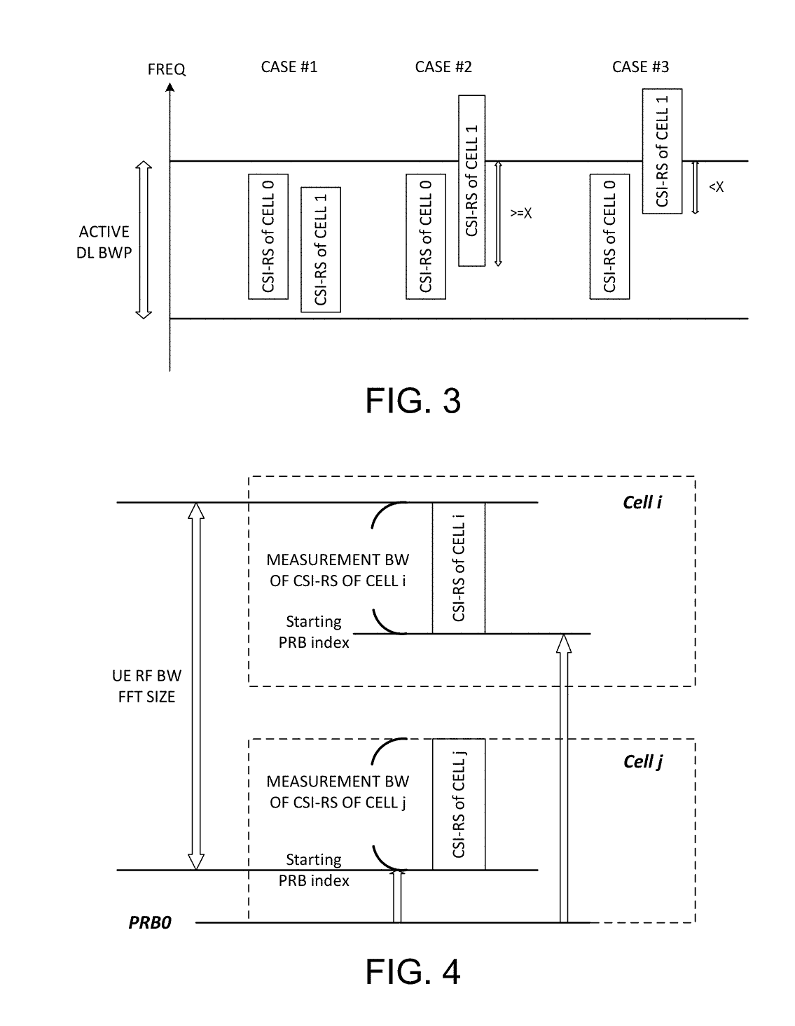

FIG. 3 illustrates frequency resources of CSI-RS for RRM measurement in accordance with one novel aspect of the present invention. As depicted in FIG. 3, an active downlink bandwidth path DL BWP is configured for UE for measurements. For intra-frequency measurements, one issue is the relationship between CSI-RS resources and the BWP. Since the CSI-RS resources and the BWP are configured separately, there could be three different cases as depicted in FIG. 3. In case 1, all configured CSI-RS resources in a measurement object are located within the active DL BWP. In case 2, some configured CSI-RS resources are located outside the active DL BWP, but the active DL BWP includes at least X physical radio blocks (PRBs) of all configured CSI-RS resources. In case 3, some configured CSI-RS resources are located outside the active DL BWP, but the active DL BWP does not include at least X PRBs of all configured CSI-RS resources. Accordingly, a measurement gap should be configured to UE when resources of CSI-RS for mobility are located outside the active DL BWP, regardless how many X PRBs within active DL BWP. Without the measurement gap, UE can measure the configured CSI-RS partially, when a CSI-RS resource with no less than X PRBs inside the DL active BWP (e.g., case 2). The value of X can be decided based on the minimum required bandwidth for measurement accuracy.

FIG. 4 illustrates additional details of frequency resources of CSI-RS for RRM measurement. In LTE, carrier-specific BW is configured for CSI-RS RRM measurements for all cells. In NR, cell-specific BW is configured for CSI-RS RRM measurements for each cell. This is because cells would have different capability of transmission BW and operators prefer to fully utilize the whole frequency band. Under cell-specific BW configuration, no common frequency location can be measured. The measurement BW and starting PRB index of CSI-RS are “cell-specific”, e.g., CSI-RS resources associated to different cells (e.g., cell i and cell j as depicted in FIG. 4) have different frequency location. Thereby, UE would be mandated to have wider RF BW and larger FFT size to receive the “union” of CSI-RS on a carrier for inter-frequency measurement. However, FFT size is the dominant factor in UE complexity for CSI-RS based RRM, and UE cannot avoid to use large FFT size with cell-specific CSI-RS BW.

For inter-frequency measurement based on CSI-RS, for a measurement object, UE is not expected to measure CSI-RS resources outside UE max DL BW. For a measurement object, UE is not expected to measure CSI-RS resources which are not overlapped with other cells in frequency domain, except 1) extended evaluation period, UE performs CSI-RS with relaxed requirement if not all CSI-RS resources on a carrier can be monitored within a certain frequency range (e.g., minimum UE BW); or 2) measurement gap is configured for UE. Further, a UE capability on UE measurement BW for measurement based on CSI-RS is reported to network. UE is not expected to monitor the CSI-RS resources outside the reported UE measurement BW for measurement based on CSI-RS.

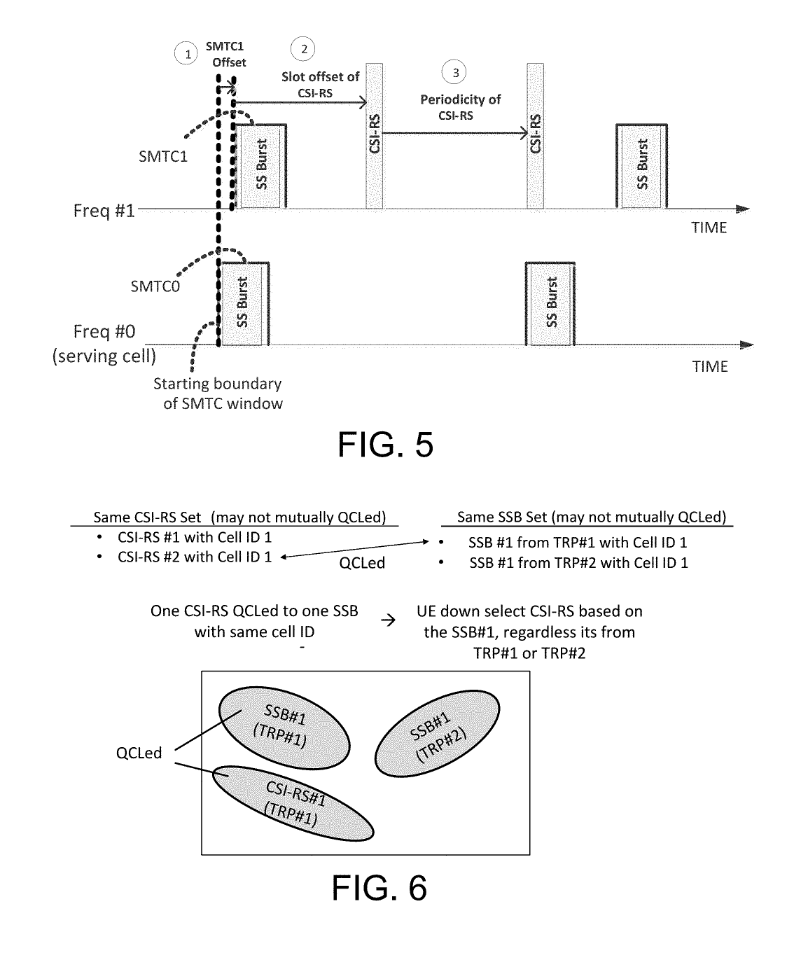

FIG. 5 illustrates one embodiment of time resources of CSI-RS for RRM measurement in accordance with one novel aspect of the present invention. Typically, UE detects SSB to acquire timing synchronization of a cell, then applies the acquired timing to measure the CSI-RS associated to the cell. For RRM measurement, the network configures not only frequency resource, but also time resource of CSI-RS. For example, the slotConfig contains periodicity and slot offset of periodically or semi-persistent CSI-RS. For each CSI-RS resource, at least one associated SSB can be configured. The CSI-RS resource is either QCLed or not QCLed with the associated SSB in spatial parameters.

The slot offset of CSI-RS for a frequency carrier is typically referenced to the frame boundary of system frame number SFN#0. If associated SSB is NOT configured, UE can assume cells on that frequency carrier are synchronized. For intra-frequency measurement, the timing reference of slot offset is the frame boundary of the serving cell. UE acquires serving cell's timing (frame, slot, symbol boundary), and UE then applies serving cell's timing to monitor CSI-RS resources. For inter-frequency measurement, the timing reference of slot offset is the frame boundary of any detected cells in the target carrier. UE acquires one of the detected cell's timing (frame, slot, symbol boundary), and UE then applies that cell's timing to monitor CSI-RS resources on that carrier (the target carrier).

For inter-frequency measurement, in order to know the frame boundary, UE needs to read PBCH for full time index, half-frame indication, and even SFN. To avoid such situation, the UE can reference the slot offset to the serving cell's timing, i.e., the timing boundary of SMTC0 window for Freq#0. As depicted in FIG. 5, UE assumes the slot offset configured for CSI-RS resources is referenced to the starting boundary of SMTC1 window of the target carrier for Freq#1, which can be configured by RRC signaling. UE first acquires the SMTC1 starting timing based on serving cell's SFN#0, i.e., SMTC1 start time=SFN#0 of serving cell+SMTC1 offset. UE then obtains the slot location of configured CSI-RS resources by shifting the SMTC1 starting timing by a configured slot offset for the CSI-RS of a target cell. UE then fine tunes the slot boundary by performing slot boundary detection for the target cell.

FIG. 6 illustrates one embodiment of utilizing QCL information in determining timing reference for CSI-RS RRM measurements. If associated SSB is configured for a CSI-RS resource, then the timing reference of slot offset is the associated SSB. UE acquires SBI (SSB index) if the cell ID configured for CSI-RS resources are detected by SSB. UE can acquire SBI by PBCH-DMRS descrambling. UE can acquire SBI by PBCH-DMRS descrambling and reading PBCH of the corresponding cell in mmWave systems. UE then obtains the slot location of configured CSI-RS resources by shifting the detected SSB by a configured slot offset for the CSI-RS of a target cell. UE then fine tunes the slot boundary by performing slot boundary detection for that target cell.

In the embodiment of FIG. 6, UE can down-select some CSI-RS to perform measurement, according to the channel quality of associated SSBs and those SSBs that are spatially QCLed to CSI-RS. If the SSB of cell A has good channel quality, then it could imply the CSI-RS of cell A could have good channel quality. Therefore, UE can down-select some CSI-RSs to perform measurements, according to the channel quality of the associated cells, rather than performing measurements on all configured CSI-RSs. In addition, the TX beam direction could be used to down-select some CSI-RSs to be measured. In the existing art, the definition of spatial QCL is unclear. Spatial QCL could mean UE can use the same RX beam to receive the QCLed RSs, or the beamforming direction of TX beams are similar. Further, in multi-TRP cell, SSB with the same index could be from different TRPs and different beam directions. As a result, UE can not leverage the QCL information to down-select some CSI-RSs to measure and it could introduce lots of measurement effort.

In one advantageous aspect, a spatial QCL-alike (SQclA) indication between an SSB set and a CSI-RS set is provided to UE for the down-selection. SQclA indication is carried by RRC signaling for CSI-RS measurement parameters. An SSB set comprises one or more SSBs, which could be transmitted from different TRPs. SSBs in the same SSB set have the same SSB time index or part of SSB time index and the same cell ID. A CSI-RS set comprises one or more CSI-RS resources. CSI-RS resources in the same CSI-RS set have the same cell ID. The SSB set and the CSI-RS set are associated to the same cell ID or scrambling ID. An SSB set and a CSI-RS set are SQclAed if any one CSI-RS of the CSI-RS set is spatial QCLed to any one SSB of the SSB set. As depicted in FIG. 6, CSI-RS set includes CSI-RS#1 with cell ID 1 and CSI-RS#2 with cell ID 1, and SSB set includes SSB#1 from TRP#1 with cell ID 1 and SSB#1 from TRP#2 with cell ID 1. The CSI-RS set is associated and SQclAed to the SSB set because CSI-RS#2 and SSB#1 (TRP#1) are spatially QCLed, e.g., having the same beam direction. With the provided SQclA information, UE can down-select CSI-RS based on either SSB#1 from the SSB set.

From UE perspective, the procedure for CSI-RS RRM measurement is as follows. In step 1, UE receives configuration for a group of CSI-RS. The configuration includes SQclA information, e.g., CSI-RS set and associated SSB set. For example, every CSI-RS is SQclAed to SSB set X (SSBs having time index X). In step 2, UE detects SSB to acquire timing synchronization of cells. In step 3, UE keeps timing of some cells, which have associated SSBs with good quality, and UE detects the time index of those SSBs. Thereby, UE knows the cell-SSB pairs having the same cell ID and the associated SSBs with good quality. In step 4, UE applies the acquired timing to measure the CSI-RS associated to the cells in the cell-SSB pairs. In step 5, UE performs measurement on the CSI-RS SQclAed to the SSBs in the cell-SSB pairs.

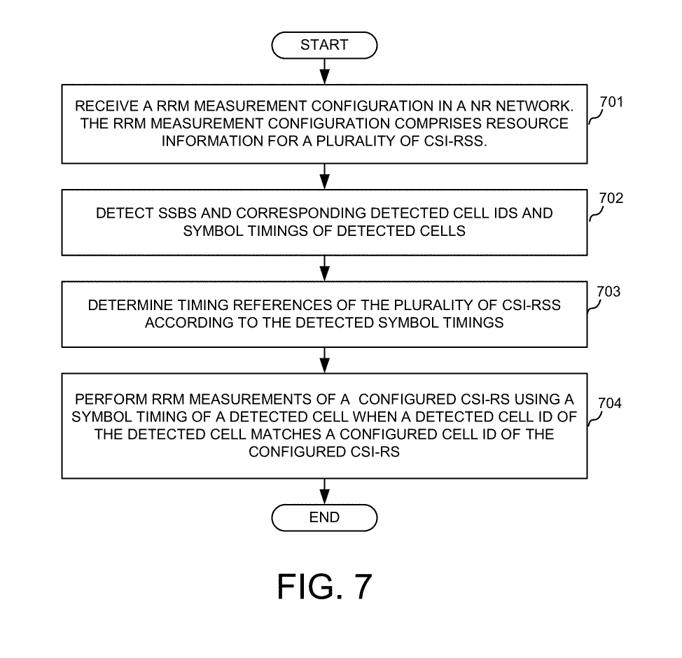

FIG. 7 is a flow chart of a method for CSI-RS RRM measurements in accordance with embodiments of the current invention. In step 701, a UE receives a radio resource management (RRM) measurement configuration in a new radio (NR) network. The RRM measurement configuration comprises resource information for a plurality of channel state information reference signals (CSI-RSs). In step 702, the UE detects synchronization signal blocks (SSBs) and corresponding detected cell IDs and symbol timings of detected cells. In step 703, the UE determines timing references of the plurality of CSI-RSs according to the detected symbol timings. In step 704, the UE performs RRM measurement of a selected CSI-RS using a symbol timing of a detected cell when a detected cell ID of the detected cell matches a configure cell ID for the selected CSI-RS.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a radio resource management (RRM) measurement configuration by a user equipment (UE) in a new radio (NR) network, wherein the RRM measurement configuration comprises resource information for a plurality of channel state information reference signals (CSI-RSs);
detecting synchronization signal blocks (SSBs) and corresponding detected cell IDs and symbol timings of detected cells;
determining timing references of the plurality of CSI-RSs according to the detected symbol timings; and
performing RRM measurement of a configured CSI-RS by the UE using a symbol timing of a detected cell when a detected cell ID of the detected cell matches a configure cell ID for the configured CSI-RS.

2. The method of claim 1, wherein the resource information comprises frequency resource location for CSI-RS measurements per cell.

3. The method of claim 1, wherein the UE is configured with an active downlink bandwidth path (DL BWP) by the network.

4. The method of claim 3, wherein the UE is configured with a measurement gap when the CSI-RS bandwidth falls outside the active DL BWP.

5. The method of claim 1, wherein a slot offset of a CSI-RS for a target cell is a frame boundary of a serving cell for intra-frequency measurement.

6. The method of claim 1, wherein a slot offset of a CSI-RS for a target cell in a target carrier is a frame boundary of any detected cell in the target carrier for inter-frequency measurement.

7. The method of claim 1, wherein the RRM measurement configuration further indicates whether the configured CSI-RS and an associated SSB with a same cell ID are spatially Quasi-Co-Located (QCLed).

8. The method of claim 7, wherein a timing reference of the configured CSI-RS is the associated SSB, and wherein the UE acquires an SSB timing and obtains a slot location of the configured CSI-RS by shifting the SSB timing by a configured slot offset of the configured CSI-RS.

9. The method of claim 7, wherein a CSI-RS set and an associated SSB set with the same cell ID are Spatial Quasi-co-locate-Aliked (SQclAed) when any one CSI-RS from the CSI-RS set is spatial QCLed to any one SSB from the associated SSB set.

10. The method of claim 9, wherein a timing reference of a CSI-RS from the CSI-RS set is any detected SSB from the associated SSB set.

11. A User Equipment (UE) comprising:
a receiver that receives a radio resource management (RRM) measurement configuration in a new radio (NR) network, wherein the RRM measurement configuration comprises resource information for a plurality of channel state information reference signals (CSI-RSs);
a detector that detects synchronization signal blocks (SSBs) and corresponding detected cell IDs and symbol timings of detected cells;
a configuration and control circuit that determines timing references of the plurality of CSI-RSs according to the detected symbol timings; and
a measurement circuit that performs RRM measurement of a configured CSI-RS using a symbol timing of a detected cell when a detected cell ID of the detected cell matches a configure cell ID for the configured CSI-RS.

12. The UE of claim 11, wherein the resource information comprises frequency resource location for CSI-RS measurements per cell.

13. The UE of claim 11, wherein the UE is configured with an active downlink bandwidth path (DL BWP) by the network.

14. The UE of claim 13, wherein the UE is configured with a measurement gap when the CSI-RS bandwidth falls outside the active DL BWP.

15. The UE of claim 11, wherein a slot offset of a CSI-RS for a target cell is a frame boundary of a serving cell for intra-frequency measurement.

16. The UE of claim 11, wherein a slot offset of a CSI-RS for a target cell in a target carrier is a frame boundary of any detected cell in the target carrier for inter-frequency measurement.

17. The UE of claim 11, wherein the RRM measurement configuration further indicates whether the configured CSI-RS and an associated SSB with a same cell ID are spatially Quasi-Co-Located (QCLed).

18. The UE of claim 17, wherein a timing reference of the configured CSI-RS is the associated SSB, and wherein the UE acquires an SSB timing and obtains a slot location of the configured CSI-RS by shifting the SSB timing by a configured slot offset of the configured CSI-RS.

19. The UE of claim 17, wherein a CSI-RS set and an associated SSB set with the same cell ID are Spatial Quasi-co-locate-Aliked (SQclAed) when any one CSI-RS from the CSI-RS set is spatial QCLed to any one SSB from the associated SSB set.

20. The UE of claim 19, wherein a timing reference of a configured CSI-RS from the CSI-RS set is any detected SSB from the associated SSB set.
